(19) United States
(12) Patent Application Publication
(10) Pub. No.: US 2026/0369236 A1
(43) Pub. Date: Nov. 19, 2026

(54) ELECTRONIC DEVICE AND METHOD FOR DRIVING ELECTRONIC DEVICE

(71) Applicant: Samsung Display Co., Ltd., Yongin-si (KR)

(72) Inventors: Yoosung KIM, Yongin-si (KR); Hyunho LIM, Yongin-si (KR)

(73) Assignee: Samsung Display Co., Ltd., Yongin-si (KR)

(21) Appl. No.: 19/549,185

(22) Filed: Feb. 25, 2026

(30) Foreign Application Priority Data
May 19, 2025 (KR) 10-2025-0064874

(51) Int. Cl. G09G 3/3275

(52) U.S. Cl. CPC G09G 3/3275; G09G 2300/0426; G09G 2300/0452; G09G 2300/0871; G09G 2330/021

(57) ABSTRACT

An electronic device comprises a plurality of first line pixel groups, a plurality of second line pixel groups, a plurality of amplifiers, a data comparison unit outputting a control signal corresponding to the result of sequentially comparing a plurality of first pixel data corresponding to the plurality of first line pixel groups and a plurality of second pixel data corresponding to the plurality of second line pixel groups, and a bias applying unit receiving the control signal from the data comparison unit and applying a bias voltage corresponding to the control signal to each of the plurality of amplifiers, wherein the data comparison unit compares each of a first difference between the plurality of first pixel data, a second difference between the plurality of second pixel data, and a third difference between the first difference and the second difference with a reference value.

### CROSS-REFERENCE TO RELATED APPLICATIONS

This U.S. non-provisional patent application claims priority under 35 U.S.C. § 119 of Korean Patent Application No. 10-2025-0064874, filed on May 19, 2025, the entire contents of which are hereby incorporated by reference.

### BACKGROUND

The present inventive concepts relates to an electronic device with reduced power consumption and to a method for driving electronic device.

Multimedia electronic devices such as a television, a mobile phone, a tablet computer, a navigation system, a game machine, and the like include a display device for displaying an image. The display device includes a display panel and a display panel driving unit. The display panel driving unit includes a scan driving circuit that provides a scan signal to each of the plurality of scan lines and a data driving circuit that provides data voltage to each of the plurality data lines.

### SUMMARY

The present disclosure provides an electronic device with reduced power consumption and a method for driving electronic device.

Some example embodiments of the inventive concepts provide an electronic device comprising a plurality of first line pixel groups, a plurality of second line pixel groups, a plurality of data lines electrically connected to the plurality of first line pixel groups and the plurality of second line pixel groups, each data line of the plurality of data lines extending in a first direction, a plurality of amplifiers electrically connected to the plurality of data lines, respectively, a data comparison unit configured to output a control signal, the data comparison unit configured to output the control signal based on a result of sequentially comparing a plurality of first pixel data corresponding to the plurality of first line pixel groups and a plurality of second pixel data corresponding to the plurality of second line pixel groups, and a bias applying unit configured to receive the control signal from the data comparison unit, the bias applying unit configured to apply a bias voltage corresponding to the control signal to each of the plurality of amplifiers, wherein the data comparison unit is configured to compare a first difference between the plurality of first pixel data with a reference value, a second difference between the plurality of second pixel data with the reference value, and a third difference between the first difference and the second difference with the reference value.

In some example embodiments, the data comparison unit is configured to output a first control signal to the bias applying unit in response to at least one of the first difference, the second difference or the third difference being greater than the reference value, and the bias applying unit is configured to apply a normal bias voltage to each of the plurality of amplifiers in response to receiving the first control signal.

In some example embodiments, the data comparison unit is configured to output a second control signal to the bias applying unit in response to all of the first difference, the second difference, and the third difference being equal to or less than the reference value, and the bias applying unit is configured to apply a low bias voltage to each of the plurality of amplifiers in response to receiving the second control signal.

In some example embodiments, the plurality of first line pixel groups includes a plurality of first red pixels, a plurality of first green pixels, and a plurality of first blue pixels, the plurality of second line pixel groups a plurality of second red pixels, a plurality of second green pixels, and a plurality of second blue pixels, each first line pixel group of the plurality of first line pixel groups includes a first red pixel of the plurality of first red pixels, a first green pixel of the plurality of first green pixels, and a first blue pixel of the plurality of first blue pixels, and each second pixel line group of the plurality of second line pixel groups includes a second red pixel of the plurality of second red pixels, a second green pixel of the plurality of second green pixels, and a second blue pixel of the plurality of second blue pixels.

In some example embodiments, the plurality of first pixel data includes a plurality of first red pixel data corresponding to the plurality of first red pixels, a plurality of first green pixel data corresponding to the plurality of first green pixels, and a plurality of first blue pixel data corresponding to the plurality of first blue pixels, and the plurality of second pixel data includes a plurality of second red pixel data corresponding to the plurality of second red pixels, a plurality of second green pixel data corresponding to the plurality of second green pixels, and a plurality of second blue pixel data corresponding to the plurality of second blue pixels.

In some example embodiments, the first difference includes a first red difference between the plurality of first red pixel data, a first green difference between the plurality of first green pixel data, and a first blue difference between the plurality of first blue pixel data, and the second difference includes a second red difference between the plurality of second red pixel data, a second green difference between the plurality of second green pixel data, and a second blue difference between the plurality of second blue pixel data.

In some example embodiments, the third difference includes a third red difference between the first red difference and the second red difference, a third green difference between the first green difference and second green difference, and a third blue difference between the first blue difference and second blue difference.

In some example embodiments, the plurality of first pixel data includes a gray scale value corresponding to each first line pixel group of the plurality of first line pixel groups, and the plurality of second pixel data includes a gray scale value corresponding to each second line pixel group of the plurality of second line pixel groups.

In some example embodiments, the reference value is a difference in gray scale value equal to 1.

In some example embodiments, the reference value is a difference in gray scale value equal to 1.

In some example embodiments, the electronic device further comprises a first scan line extending in a second direction intersecting the first direction and electrically connected to the plurality of first line pixel groups, and a second scan line extending in the second direction and electrically connected to the plurality of second line pixel groups.

In some example embodiments, the electronic device further comprises a latch that is configured to sequentially store a plurality of pixel data including the plurality of first pixel data and the plurality of second pixel data, a control unit including the data comparison unit and configured to output the plurality of pixel data to the latch, a level shifter configured to receive the plurality of pixel data from the latch, the level shifter further configured to change voltage levels of the plurality of pixel data received from the latch, and a conversion unit configured to receive the plurality of pixel data in digital form, the conversion unit further configured to convert the plurality of pixel data into a plurality of data voltages in analog form using a gamma reference value.

In some example embodiments, the electronic device further comprises a plurality of third line pixel groups, and a plurality of fourth line pixel groups, wherein the data comparison unit is further configured to compare a plurality of third pixel data corresponding to the plurality of third line pixel groups and a plurality of fourth pixel data corresponding to the plurality of fourth line pixel groups.

Some example embodiments of the inventive concepts provide a method for driving an electronic device. The method comprising receiving a plurality of first pixel data corresponding to a plurality of first line pixel groups and a plurality of second pixel data corresponding to a plurality of second line pixel groups, comparing a first difference between the plurality of first pixel data with a reference value, comparing a second difference between the plurality of second pixel data with the reference value, comparing a third difference between the first difference and the second difference with the reference value, and outputting a first control signal to a bias applying unit when at least one of the first difference, the second difference, and the third difference is greater than the reference value, and outputting a second control signal to the bias applying unit when all of the first difference, the second difference, and the third difference are equal to or less than the reference value.

In some example embodiments, the bias applying unit applies a normal bias voltage corresponding to the first control signal to each of a plurality of amplifiers in response to the bias applying unit receiving the first control signal, and applies a low bias voltage corresponding to the second control signal to each of the plurality of amplifiers in response to receiving the second control signal.

In some example embodiments, the plurality of first line pixel groups includes a plurality of first red pixels, a plurality of first green pixels, and a plurality of first blue pixels, the plurality of second line pixel groups includes a plurality of second red pixels, a plurality of second green pixels, and a plurality of second blue pixels, each first line pixel group of the plurality of first line pixel groups includes a first red pixel of the plurality of first red pixels, a first green pixel of the plurality of first green pixels, and a first blue pixel of the plurality of first blue pixels, and each second line pixel group of the plurality of second line pixel groups includes a second red pixel of the plurality of second red pixels, a second green pixel of the plurality of second green pixels, and a second blue pixel of the plurality of second blue pixels.

In some example embodiments, the plurality of first pixel data includes a plurality of first red pixel data corresponding to the plurality of first red pixels, a plurality of first green pixel data corresponding to the plurality of first green pixels, and a plurality of first blue pixel data corresponding to the plurality of first blue pixels, and the plurality of second pixel data includes a plurality of second red pixel data corresponding to the plurality of second red pixels, a plurality of second green pixel data corresponding to the plurality of second green pixels, and a plurality of second blue pixel data corresponding to the plurality of second blue pixels.

In some example embodiments, the first difference includes a first red difference between the plurality of first red pixel data, a first green difference between the plurality of first green pixel data, and a first blue difference between the plurality of first blue pixel data, the second difference includes a second red difference between the plurality of second red pixel data, a second green difference between the plurality of second green pixel data, and a second blue difference between the plurality of second blue pixel data, and the third difference includes a third red difference between the first red difference and the second red difference, a third green difference between the first green difference and second green difference, and a third blue difference between the first blue difference and second blue difference.

In some example embodiments, the plurality of first pixel data includes a plurality of first gray scale values, each first gray scale value of the plurality of first gray scale values corresponding to a respective first line pixel group of the plurality of first line pixel groups, the plurality of second pixel data includes a plurality of second gray scale values, each second gray scale value of the plurality of second gray scale values corresponding to a respective second line pixel group of the plurality of second line pixel groups, and the reference value is a difference in gray scale value equal to 1.

Some example embodiments of the inventive concept provide an electronic device comprising a display panel including a plurality of pixel groups, a data driving circuit configured to output a plurality of data voltages, each data voltage of the plurality of data voltages corresponding to a respective pixel group of the plurality of pixel groups, and a processor configured to control the display panel and the data driving circuit, wherein the data driving circuit includes a data comparison unit configured to output a control signal, the data comparison unit configured to output the control signal based on a result of sequentially comparing a plurality of first pixel data corresponding to a plurality of first line pixel groups and a plurality of second pixel data corresponding to a plurality of second line pixel groups, a bias applying unit configured to receive the control signal from the data comparison unit, the bias applying unit further configured to output a bias voltage corresponding to the control signal, and a plurality of amplifiers configured to receive the bias voltage from the bias applying unit, wherein the data comparison unit is configured to compare a first difference between the plurality of first pixel data with a reference value, a second difference between the plurality of second pixel data with the reference value, and a third difference between the first difference and the second difference with the reference value.

According to the foregoing, the electronic device may comprise a data comparison unit comparing a plurality of pixel data corresponding to a plurality of pixel groups to output a control signal, and a bias applying unit applying a bias voltage corresponding to the control signal to each of the plurality of amplifiers. When the difference between the pixel data is small, the output change of the data voltages corresponding to the pixel data may be small, so that a high bias voltage is not required. Therefore, when the difference between the pixel data is small, the data comparison unit may output a control signal corresponding to a low bias voltage to reduce power consumption of the electronic device. In addition, the data comparison unit may be configured with one data comparison block to sequentially compare pixel data. Thus, the data comparison unit may generate a control signal that controls the bias voltage without increasing the size of the data driving circuit. As the bias voltage is controlled, power consumption of the electronic device may be reduced.

### BRIEF DESCRIPTION OF THE FIGURES

FIG. 1 is a block diagram of an electronic device according to some example embodiments of the inventive concepts.

FIG. 2 is schematic diagrams of an electronic device according to some example embodiments of the inventive concepts.

FIG. 3 is a block diagram of an electronic device according to some example embodiments of the inventive concepts.

FIG. 4 is a diagram illustrating an arrangement of some pixel groups according to some example embodiments of the inventive concepts.

FIG. 5 is a block diagram of a data driving circuit according to some example embodiments of the inventive concepts.

FIG. 6 is a diagram for describing a driving principle of a data comparison unit according to some example embodiments of the inventive concepts.

FIG. 7 is a diagram for describing a driving principle of a data comparison unit according to some example embodiments of the inventive concepts.

FIG. 8 is a diagram for describing timing at which bias voltages corresponding to each of the first period and the second period are applied according to some example embodiments of the inventive concepts.

FIG. 9 is a diagram for describing a driving principle of a data comparison unit according to some example embodiments of the inventive concepts.

### DETAILED DESCRIPTION

In this specification, when a component (or region, layer, portion, etc.) is referred to as being “on,” “connected,” or “coupled to” another component, it means that it may be directly disposed/connected/coupled to the other component or a third component may be disposed therebetween.

Like reference numerals refer to like elements. In addition, in the drawings, the thicknesses, ratios, and dimensions of the components are exaggerated for effective description of the technical content. The term “and/or” includes all of one or more combinations that the associated components may define.

The terms first, second, etc. may be used to describe various components, but the components should not be limited by the terms. The terms are used only for the purpose of distinguishing one component, part, region, layer or portion from another component, part, area, layer or portion. For example, a first component, a first part, a first region, a first layer, or a first portion may be termed a second component, a second part, a second region, a second layer, or a second portion, and similarly a second component, second part, second region, second layer, or second portion may also be termed a first component, first part, first region, first layer, or first portion without departing from the scope of the present inventive concepts. The singular forms “a”, “an” and “the” include a plurality of referents unless the context clearly dictates otherwise.

In addition, the terms “below”, “under”, “on the lower side”, “above”, “over”, “on the upper side”, or the like may be used to describe the relationships between the elements illustrated in the drawings. These terms are relative concepts and are described on the basis of the directions indicated in the drawings.

It will be further understood that the terms “comprises, includes, has” and/or “comprising, including, having”, when used in this specification, specify the presence of stated features, numbers, steps, operations, elements, components, or combinations thereof, but do not preclude the possibility of the presence or addition of one or more other features, numbers, steps, operations, elements, components, and/or combinations thereof.

Unless otherwise defined, all terms (including technical and scientific terms) used herein have the same meaning as commonly understood by one of ordinary skills in the art to which these inventive concepts belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, some example embodiments of the present inventive concepts are described with reference to the drawings.

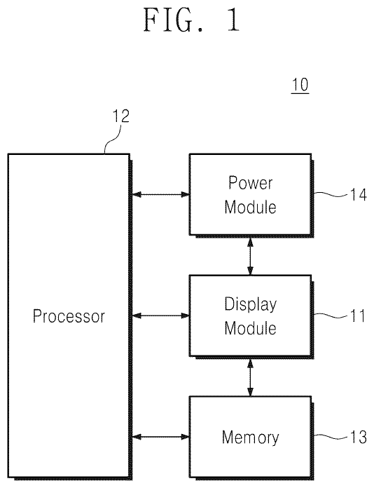

FIG. 1 is a block diagram of an electronic device 10 according to some example embodiments.

Referring to FIG. 1, the electronic device 10 according to some example embodiments may include a display module 11, a processor 12, a memory 13, and a power supply module 14.

The display module 11 may display an image. The image may comprise a still image as well as a dynamic image. The processor 12 may include at least one of a central processing unit (CPU), an application processor (AP), a graphics processing unit (GPU), a communication processor (CP), an image signal processor (ISP), and a controller. The processor 12 may be configured to control the operation of the display module 11.

The memory 13 may store data information necessary for operation of the processor 12 or the display module 11. When the processor 12 executes the application stored in the memory 13, the image data signal and/or the input control signal are transmitted to the display module 11, and the display module 11 may process the received signal to output image information through the display screen.

The power supply module 14 may comprise a power supply module such as a power adapter or a battery device, and a power conversion module converting power supplied by the power supply module to generate power required for operation of the electronic device 10.

As described herein, any devices, systems, modules, portions, units, controllers, circuits, and/or portions thereof according to any of the example embodiments, and/or any portions thereof may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

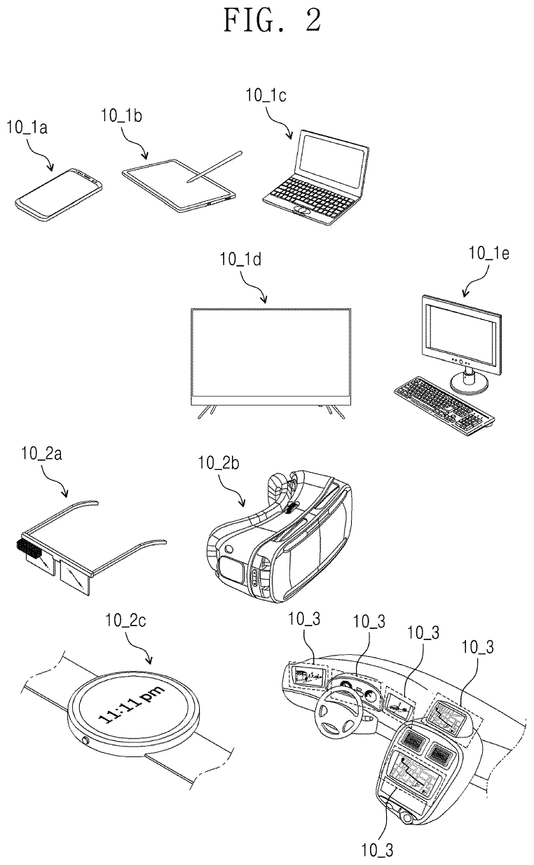

FIG. 2 is schematic diagrams of an electronic device according to various embodiments of the present inventive concepts.

Referring to FIG. 2, various electronic devices to which a display device according to some example embodiments may be applied may include an electronic device for image display such as a smartphone 10_1a, a tablet PC 10_1b, a laptop 10_1c, a TV 10_1d, and a desk monitor 10_1e, as well as a wearable electronic device including a display module such as smart glasses 10_2a, a head mounted display 10_2b, a smart watch 10_2c, and the like, an automotive electronic device 10_3 including a display module, such as a CID (Center Information Display) disposed on an instrument panel, a center fascia, and a dashboard of a vehicle, a room mirror display, and the like.

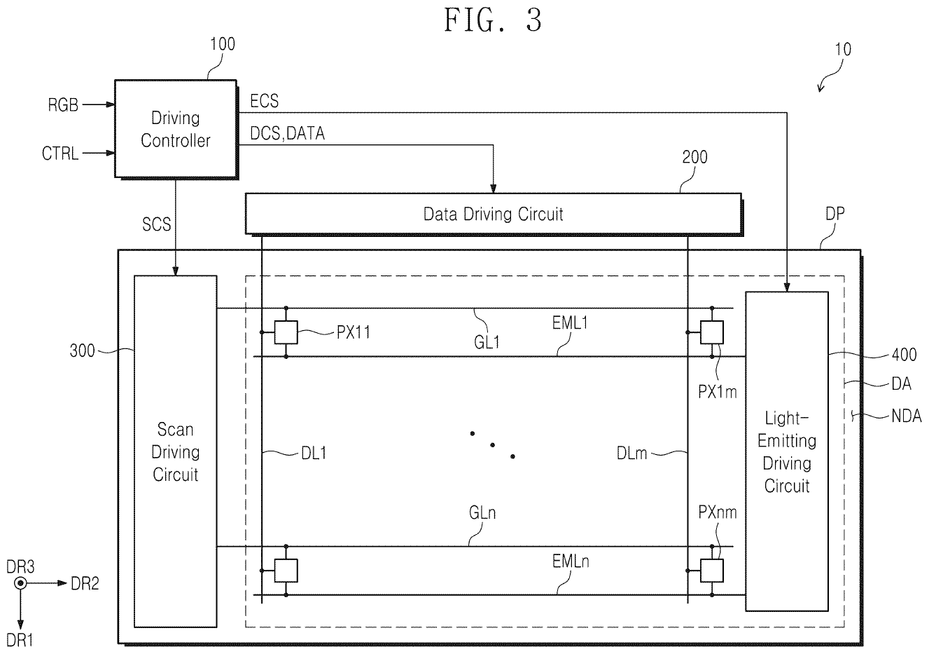

FIG. 3 is a block diagram of an electronic device 10 according to some example embodiments of the present inventive concepts.

Referring to FIG. 3, the electronic device 10 may include a driving controller 100, a data driving circuit 200, and a display panel DP.

The driving controller 100 may be configured to control the data driving circuit 200 and the display panel DP. The driving controller 100 may receive an input image signal RGB and a control signal CTRL. The driving controller 100 may generate an output image signal DATA obtained by converting the input image signal RGB into an image type suitable for the display panel DP. The driving controller 100 may output a scan control signal SCS and a data control signal DCS. The driving controller 100 may correspond to the processor 12 shown in FIG. 1.

The data driving circuit 200 may receive the data control signal DCS and the output image signal DATA from the driving controller 100. The data driving circuit 200 may convert the output image signal DATA into data voltages (or data signals) and output the data voltages to the data lines DL1-DLm. Each of the data voltages may have a voltage level corresponding to a gray level of the output image signal DATA. Accordingly, the data driving circuit 200 may output corresponding data voltages to each of the data lines DL1-DLm.

The data driving circuit 200 may be implemented as an integrated circuit (IC) and directly mounted on a predetermined or alternatively desired area of the display panel DP, or may be mounted on a separate printed circuit board in a chip on film (COF) manner and electrically connected to the display panel DP. In some example embodiments, the data driving circuit 200 may be formed in the same process as the pixel circuit of each of the pixel groups PX11-PXnm on the display panel DP.

The display panel DP may include a plurality of scan lines GL1-GLn, a plurality of data lines DL1-DLm, a plurality of light-emitting control lines EML1-EMLn, and a plurality of pixel groups PX11-PXnm. n may be an integer of 2 or more, and m may be an integral of 2 or more.

The display panel DP according to some example embodiments of the present inventive concepts may be a light-emitting display panel. For example, the display panel DP may be an organic light-emitting display panel, an inorganic light-emitting display panel or a quantum dot light-emitting display panel. The light-emitting layer of the organic light-emitting display panel may include an organic light-emitting material. The light-emitting layer of the inorganic light-emitting display panel may include an inorganic light-emitting material. The light-emitting layer of the quantum dot light-emitting display panel may include a quantum dot, a quantum rod, and the like. Hereinafter, the display panel DP in the example embodiments is described as an organic light-emitting display panel.

The display panel DP may include a display area DA and a non-display area NDA. In some example embodiments, the display area DA has a rectangular shape, but the present inventive concepts are not limited thereto. The non-display area NDA may have a frame shape surrounding the display area DA.

The display panel DP may further include a scan driving circuit 300 and a light-emitting driving circuit 400. The pixel groups PX11-PXnm may be disposed in the display area DA, and the scan driving circuit 300 and the light-emitting driving circuit 400 may be disposed in a non-display area NDA. However, the present inventive concepts are not limited thereto, and the scan driving circuit 300 and the light-emitting driving circuit 400 may be disposed in the display area DA.

The scan lines GL1-GLn are arranged to be spaced apart from each other in the first direction DR1, and each of the scan lines GL1 to GLn may extend from the scan driving circuit 300 in the second direction DR2. The light-emitting control lines EML1-EMLn are arranged to be spaced apart from each other in the first direction DR1, and each of the light-emitting control lines EML1-EMLn may extend from the light-emitting driving circuit 400 in a direction opposite to the second direction DR2. Each of the data lines DL1-DLm extends from the data driving circuit 200 in the first direction DR1 and may be arranged to be spaced apart from each other in the second direction DR2.

The pixel groups PX11-PXnm may be arranged in the first direction DR1 and the second direction DR2. Each of the pixel groups PX11-PXnm may include a plurality of sub-pixels, and one pixel group PX may be connected to a plurality of data lines. For example, when one pixel group PX includes a red sub-pixel, a green sub-pixel, and a blue sub-pixel, one pixel group PX may be connected to three data lines. FIG. 3 representatively depicts a data line connected to one sub-pixel of the three data lines.

In some example embodiments of the present inventive concepts, each of a plurality of sub-pixels included in each of the pixel groups PX11-PXnm may be electrically connected to one scan line and one data line. Each of the sub-pixels included in each of the pixel groups PX11-PXnm may include a light-emitting element and a pixel circuit that controls light-emitting of the light-emitting element.

The scan driving circuit 300 may receive the scan control signal SCS from the driving controller 100. The scan driving circuit 300 may output scan signals to the scan lines GL1-GLn in response to the scan control signal SCS.

The light-emitting driving circuit 400 may receive the light-emitting driving signal ECS from the driving controller 100. The light-emitting driving circuit 400 may output light-emitting control signals to the light-emitting control lines EML1-EMLn in response to the light-emitting driving signal ECS.

Each of the scan driving circuit 300 and the light-emitting driving circuit 400 may be implemented as an integrated circuit (IC) and directly mounted on a predetermined or alternative desired area of the display panel DP or mounted on a separate printed circuit board in a chip on film (COF) manner to be electrically connected to the display panel DP. In some example embodiments, each of the scan driving circuit 300 and the light-emitting driving circuit 400 may be formed in the same process as the pixel circuit of each of the pixel groups PX11-PXnm on the display panel DP. In addition, the scan driving circuit 300 and the light-emitting driving circuit 400 may be configured as one driving circuit that is not separate.

The driving controller 100, the data driving circuit 200, the scan driving circuit 300, and the light-emitting driving circuit 400 may be driving circuits for providing data voltages corresponding to the input image signal RGB to the pixel groups PX11-PXnm.

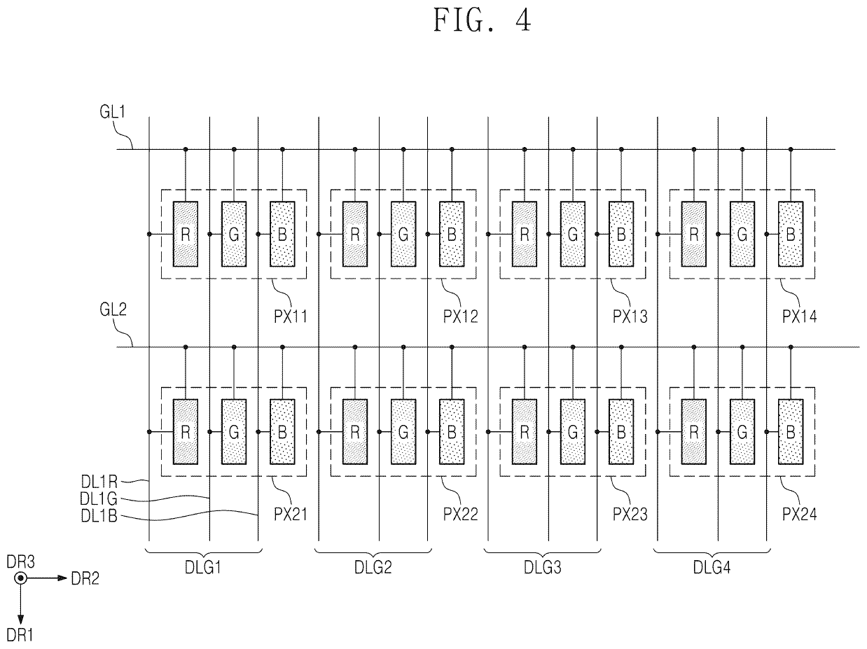

FIG. 4 is a diagram exemplarily illustrating an arrangement of some pixel groups PX11-PX14 and PX21-PX24 according to some example embodiments of the present inventive concepts.

Referring to FIGS. 3 and 4, the display panel DP may include pixel groups PX11-PX14 and PX21-PX24, a plurality of data line groups DLG1-DLG4, and scan lines GL1 and GL2. FIG. 4 illustrates some example embodiments of the pixel groups PX11-PXnm, for example, eight pixel groups PX 11-PX14 and PX21-PX24. In addition, in FIG. 4, four data line groups DLG1-DLG4 and two scan lines GL1 and GL2 electrically connected to the eight pixel groups PX11-PX14 and PX21-PX24 are shown according to some example embodiments. Hereinafter, the four data line groups DLG1 to DLG4 may be referred to as first to fourth data line groups DLG1 to DLG4, respectively, and the two scan lines GL1 and GL2 may be referred to as first to second scan lines GL1, GL2, respectively. In addition, the eight pixel groups PX11-PX14 and PX21-PX24 may be referred to as first to eighth pixel groups PX 11-PX14 and PX 21-PX24, respectively.

The pixel groups PX11-PX14 and PX21-PX24 may include a plurality of first line pixel groups PX1-PX14 and a plurality of second line pixel groups PX21-PX24. The first line pixel groups PX11-PX14 may be pixel groups PX11-PX14 electrically connected to the first scan line GL1 and arranged in the second direction DR2, and the second line pixel groups PX21-PX24 may be pixel groups PX21-PX24 electrically connected to the second scan line GL2 and arranged in the second direction DR2.

In some example embodiments of the present inventive concepts, each of the first line pixel groups PX11-PX14 may include a plurality of sub-pixels R, G, and B. For example, each of the first line pixel groups PX11-PX14 may include a first red pixel R, a first green pixel G, and a first blue pixel B. That is, the first line pixel groups PX11-PX14 may include a plurality of first red pixels R, a plurality of first green pixels G, and a plurality of first blue pixels B.

Each of the second line pixel groups PX21-PX24 may include a plurality of sub-pixels R, G, and B. For example, each of the second line pixel groups PX21-PX24 may include a second red pixel R, a second green pixel G, and a second blue pixel B. That is, the second line pixel groups PX21-PX24 may include a plurality of second red pixels R, a plurality of second green pixels G, and a plurality of second blue pixels B. In some example embodiments, the first red pixel R may have the same circuit configuration as the second red pixel R, the first green pixel G may have the same network configuration as the second green pixel G, and the first blue pixel B may have the same channel configuration as the second blue pixel B.

In addition, in some example embodiments, each of the first line pixel groups PX11-PX14 and the second line pixel groups PX21-PX24 may further include various color pixels such as yellow, cyan, magenta, and white, or may include a plurality of green pixels. That is, the combination of pixels constituting each of the first line pixel groups PX11-PX14 and the second line pixel groups PX21-PX24 may be variously modified.

In some example embodiments of the present inventive concepts, one of the data line groups DLG1-DLG4 may include a plurality of data lines. For example, the first data line group DLG1 may include 1-1 to 1-3 data lines DL1R, DL1G, and DL1B. In some example embodiments, the 1-1 data line DL1R may be electrically connected to the first red pixel R of the first pixel group PX11 and the second red pixel R of the fifth pixel group PX21 spaced apart from the first pixel groups PX11 in the first direction DR1. The 1-2 data line DL1G may be electrically connected to the first green pixel G of the first pixel group PX11 and the second green pixel G of the fifth pixel group PX21, and the 1-3 data line DL1B may be electrically connected to the first blue pixel B of the first pixel groups PX11 and the second blue pixels B of the fifth pixel groups PX21.

Although the first to first to third data lines DL1R, DL1G, and DL1B of the first data line group DLG1 are described in with reference to FIG. 4, the same description may be applied to the second to fourth data line groups DLG2 to DLG4. Hereinafter, descriptions of the second to fourth data line groups DLG2 to DLG4 are omitted.

In some example embodiments of the present inventive concepts, in the first line pixel groups PX11 to PX14, the first red pixel R, the first green pixel G, and the first blue pixel B may be repeatedly arranged in order along the second direction DR2, and in the second line pixel groups PX21 to PX24, the second red pixel R, the second green pixel G, the second blue pixel B may be repeatedly arranged, in order, along the second direction DR2. For example, the first line pixel groups PX11-PX14 may be arranged in the order of a first red pixel R, a first green pixel G, a first blue pixel B, a first red pixel R, a first green pixel G, and a first blue pixel B in the second direction, and the second line pixel groups PX21-PX24 may be arranged in an order of a second red pixel R, a second green pixel G, a second blue pixel B, a second red pixel R, a second green pixel G, and a second blue pixel B in the second direction. However, the present inventive concepts are not limited thereto, and each of the arrangement relationship of sub-pixels and the arrangement relationship of pixel groups may be variously changed.

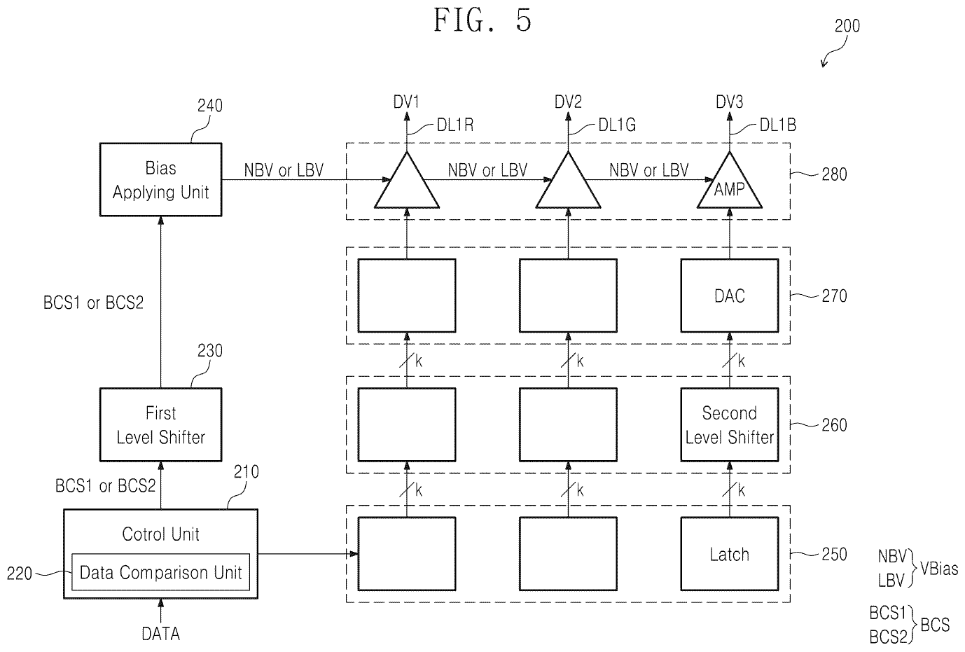

FIG. 5 is a block diagram of a data driving circuit 200 according to some example embodiments of the present inventive concepts.

Referring to FIG. 5, the data driving circuit 200 may include a control unit 210, a first level shifter 230, a bias applying unit 240, a latch 250, a second level shifter 260, a conversion unit 270, and an output unit 280.

The control unit 210 may receive the output image signal DATA from the driving controller 100 (see FIG. 3) or the outside. The control unit 210 may parallelize the serialized output image signal DATA received from the driving controller 100 (see FIG. 3) or the outside. The control unit 210 may output the parallelized output image signals DATA to the latch 250. Hereinafter, the output image signals DATA may be referred to as pixel data DATA.

In some example embodiments of the present inventive concepts, the control unit 210 may include a data comparison unit 220. The data comparison unit 220 may sequentially compare the pixel data DATA and calculate a result value. For example, the data comparison unit 220 may sequentially compare a gray scale value corresponding to each of the pixel data DATA with one or more reference values stored in advance (e.g., a reference value stored within the data driving circuit 200) and calculate the result value.

In some example embodiments of the present inventive concepts, the data comparison unit 220 may generate a control signal BCS corresponding to the result value. For example, the data comparison unit 220 may generate the first control signal BCS1 or the second control signal BCS2 according to the result value. The data comparison unit 220 may transmit the generated first control signal BCS1 or second control signal BCS2 to the bias applying unit 240 via the first level shifter 230.

Unlike the present inventive concepts, when the amount of change in data provided for each channel (e.g., data lines) is compared, a data comparison block (or circuit) corresponding to the number of channels is additionally required, so that the size of the driving circuit can be increased. However, according to the present inventive concepts, since the data comparison unit 220 sequentially compares the parallelized pixel data DATA, the data comparison unit 220 may be configured as one data comparison block in the control unit 210. Accordingly, the data comparison unit 220 may generate the first control signal BCS1 or the second control signal BCS2 that controls the bias voltage VBias generated by the bias applying unit 240 without increasing the size of the data driving circuit 200. As the bias voltage VBias is controlled, power consumption of the electronic device 10 (see FIG. 1) may be reduced. The data comparison unit 220 will be described in detail below.

The first level shifter 230 may receive the control signal BCS from the data comparison unit 220. The first level shifter 230 may change the voltage level of the control signal BCS. For example, the first level shifter 230 may change the voltage level of the control signal BCS received from the data comparison unit 220 to a voltage level corresponding to the bias applying unit 240. The control signal BCS may be referred to as a bias control signal BCS.

The bias applying unit 240 may receive the first control signal BCS1 or the second control signal BCS2 output from the data comparison unit 220 via the first level shifter 230. The bias applying unit 240 may generate bias voltages VBias having various voltage levels in response to the first control signal BCS1 or the second control signal BCS2.

In some example embodiments of the present inventive concepts, the bias applying unit 240 may generate a normal bias voltage NBV when receiving the first control signal BCS1, and may generate a low bias voltage LBV when receiving the second control signal BCS2. The bias applying unit 240 may output the generated normal bias voltage NBV or low bias voltage LBV to the plurality of amplifiers AMP.

According to some example embodiments of the present inventive concepts, the data comparison unit 220 may sequentially compare the pixel data DATA to generate the first control signal BCS1 or the second control signal BCS2, and the bias applying unit 240 may output a normal bias voltage NBV or a low bias voltage LBV corresponding to the first control signal BCS1 or the second controls signal BCS2 to the amplifiers AMP. The voltage level of the normal bias voltage NBV may be higher than the voltage level of the low bias voltage LBV.

When the difference between the pixel data DATA is small, for example, when the pixel data DATA is a monochrome pattern, the output change of the data voltages DV1, DV2, and DV3 corresponding to the pixel data DAT is small, so that a high bias voltage may not be required. Accordingly, when the difference between the pixel data DATA is small, the data comparison unit 220 outputs the second control signal BCS2, and the bias applying unit 240 applies the low bias voltage LBV corresponding to the second control signal BCS2 to the amplifiers AMP, thereby reducing power consumption of the electronic device 10 (see FIG. 1).

Although not shown, the data driving circuit 200 may further include a shift register unit including a plurality of shift registers. The shift register unit may receive the parallelized pixel data DATA from the control unit 210 and provide it to the latch 250. The shift register unit may generate and provide latch clock signals to the latch 250, and the latch clock signals may be used to control timing at which the parallelized pixel data DATA is output. In some example embodiments, the shift register unit may be included in the control unit 210 or omitted.

The latch 250 may receive the parallelized pixel data DATA from the control unit 210 or the shift register unit. The latch 250 may sequentially store the parallelized pixel data DATA corresponding to the latch clock signals. Accordingly, the latch portion 250 may include a plurality of latches. The latch 250 may output stored pixel data DATA corresponding to each of the data lines DL1R, DL1G, and DL1B.

In some example embodiments of the present inventive concepts, each of the pixel data DATA may be k-bit(s) data. k may be a natural number greater than or equal to 1. In some example embodiments, k may be 8.

In FIG. 5, the 1-1 data line DL1R, the 1-2 data line DL2G, and the 1-3 data line DL3B of the first data line group DLG1 shown in FIG. 4 are shown and described as example embodiments, and the same description may be applied to data lines not shown. Hereinafter, description of data lines not shown is omitted.

The second level shifter 260 may receive the pixel data DATA from the latch 250. The second level shifter 260 may change the voltage level of the pixel data DATA. For example, the second level shifter 260 may change the voltage level of the pixel data DATA received from the latch 250 to a voltage level corresponding to the conversion unit 270. In some example embodiments, each of the first level shifter 230 and the second level shifter 260 may both be referred to as a level shifter 230 or 260. Further, in some example embodiments, the first level shifter 230 and the second level shifter 260 may be configured as one.

The conversion unit 270 may receive the pixel data DATA whose voltage level is changed from the second level shifter 260. The conversion unit 270 may include a plurality of digital-to-analog converters (DACs). The conversion unit 270 may convert the digital pixel data DATA into analog data voltages DV1, DV2, and DV3, respectively, using a gamma reference value. Data voltages DV1, DV2, and DV3 in analog form may be transferred to corresponding data lines DL1R, DL1G, and DL1B, respectively.

The output unit 280 may include a plurality of amplifiers AMP electrically connected to the data lines DL1R, DL1G, and DL1B, respectively. The amplifiers AMP may receive the data voltages DV1, DV2, and DV3 from the conversion unit 270, and may receive the bias voltage VBias from the bias applying unit 240. The current of the amplifiers AMP may be controlled in response to the received bias voltage VBias. Accordingly, the amplifiers AMP may stably transmit the data voltages DV1, DV2, and DV3 to the data lines DL1R, DL1G, and DL1B, respectively, according to the corresponding bias voltage VBias.

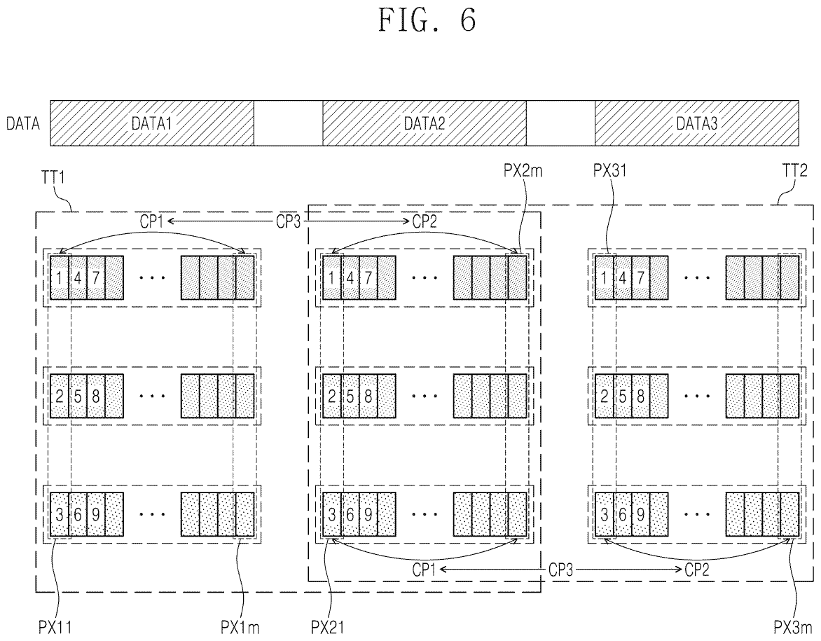

FIG. 6 is a diagram for explaining a driving principle of the data comparison unit 220 (see FIG. 5) according to some example embodiments of the present inventive concepts.

Referring to FIGS. 5 and 6, the pixel data DATA may include a first pixel data DATA1, a second pixel data DATA2, and a third pixel data DATA3.

The first pixel data DATA1 may be data corresponding to the first line pixel groups PX11-PX1m electrically connected to the first scan line GL1 (see FIG. 4), and the second pixel data DATA2 may be data corresponding the second line pixel groups PX21-PX2m electrically connected to a second scan line GL2 (see FIG. 4). In addition, the third pixel data DATA3 may be data corresponding to third line pixel groups PX31-PX3m electrically connected to a third scan line (not shown).

In some example embodiments of the present inventive concepts, the data comparison unit 220 may compare data corresponding to pixel groups connected to the two scan lines. For example, the data comparison unit 220 may compare the first pixel data DATA1 corresponding to the first line pixel groups PX11-PX1m connected to the first scan line GL1 and the second pixel data DATA2 corresponding to the second line pixel groups PX21-PX2m connected to the second scan line GL2.

In some example embodiments of the present inventive concepts, the data comparison unit 220 may output the control signal BCS corresponding to a result value obtained by comparing the first pixel data DATA1 and the second pixel data DATA2 to the bias applying unit 240.

In some example embodiments of the present inventive concepts, the data comparison unit 220 may compare each of a first difference CP1 between the first pixel data DATA1, a second difference CP2 between the second pixel data DATA2, and a third difference CP3 between the first difference CP1 and the second difference CP2 with a reference value, respectively.

In some example embodiments of the present inventive concepts, the first pixel data DATA1 may include a gray scale value corresponding to each of the first line pixel groups PX11-PX1m, and the second pixel data DATA2 may include a gray scale value corresponding to the each of the second line pixel groups PX21-PX2m.

Accordingly, the data comparison unit 220 may compare the first difference CP1 in the gray scale corresponding to the first line pixel groups PX11-PX1m, the second difference CP2 in the gray scale corresponding to the second line pixel groups PX21-PX2m, and the third difference CP3 in the gray scales corresponding to the first lines pixel groups PX11-PX1m and the second lines pixel groups PX21-PX2m.

In some example embodiments of the present inventive concepts, the first difference CP1 may be a maximum value of a difference of each of the entire gray scales when all of the gray scales corresponding to the first line pixel groups PX11-PX1m are compared. For example, when the difference in the gray scale corresponding to each of the first line pixel group PX11 and the last line pixel group PX1m is the maximum value, the first difference CP1 may be the difference between the gray scales corresponding to each the first line pixel groups PX11 and PX1m. That is to say, in some example embodiments, the first difference CP1 may represent a difference in gray scale value between a gray scale value of a first pixel group of the first line pixel groups PX11-PX1m that has a largest gray scale value among the first line pixel groups PX11-PX1m (e.g., a maximum gray scale value) and a gray scale value of a second pixel group of the first line pixel groups PX11-PX1m that has a smallest gray scale value among the first line pixel groups PX11-PX1m (e.g., a minimum gray scale value) such that the first difference CP1 represents a maximum difference in gray scale value between two pixel groups among the first line pixel groups PX11-PX1m. Although the first difference CP1 is used as an example, the second difference CP2 may also be a maximum value of the difference of each of the entire gray scales when all of the gray scales corresponding to the second line pixel groups PX21-PX2m are compared. For example, in some example embodiments, the second difference CP2 may represent a difference in gray scale value between a gray scale value of a first pixel group of the second line pixel groups PX21-PX2m that has a largest gray scale value among the second line pixel groups PX21-PX2m (e.g., a maximum gray scale value) and a gray scale value of a second pixel group of the second line pixel groups PX21-PX2m that has a smallest gray scale value among the second line pixel groups PX21-PX2m (e.g., a minimum gray scale value) such that the second difference CP2 represents a maximum difference in gray scale value between two pixels groups among the second line pixel groups PX11-PX1m.

In some example embodiments of the present inventive concepts, the third difference CP3 may be a value obtained by comparing the first difference CP1, which is the maximum value of the difference of each of the entire gray scales corresponding to the first line pixel groups PX11-PX1m, with the second difference CP2, which is the maximum value of the difference of the respective entire gray scales corresponding to the second line pixel groups PX21-PX2m. For example, in some example embodiments, the third difference CP3 may be the difference between the value of the first difference CP1 and the value of the second difference CP2.

In some example embodiments of the present inventive concepts, the data comparison unit 220 may compare each of the first difference CP1, the second difference CP2, and the third difference CP3 with a reference value.

In some example embodiments of the present inventive concepts, the reference value may be a case when the difference in gray scale is 1. Therefore, when the reference value is 1, the maximum value of the difference of each of the entire gray scales corresponding to the first line pixel groups PX11-PX1m may be compared with 1, the maximum value of the difference of each of the entire gray scales corresponding to the second line pixel groups PX21-PX2m may be compared with 1, and the difference between the maximum value of the difference of each of the entire gray scales corresponding to the first line pixel groups PX11-PX1m and the maximum value of the difference of each of the entire gray scales corresponding to the second line pixel groups PX21-PX2m may be compared with 1. However, it is not limited to this, and the reference value may be a case when the difference in gray scale is 10. In addition, the reference value may be changed to various values.

When at least one of the first difference CP1, the second difference CP2, and the third difference CP3 is greater than the reference value, the data comparison unit 220 may output the first control signal BCS1 to the bias applying unit 240. In addition, when all of the first difference CP1, the second difference CP2, and the third difference CP3 are equal to or less than the reference value, the data comparison unit 220 may output the second control signal BCS2 to the bias applying unit 240.

In some example embodiments of the present inventive concepts, the data comparison unit 220 may compare the second pixel data DATA2 corresponding to the second line pixel groups PX21-PX2m connected to the second scan line GL2 (see FIG. 4) and the third pixel data DATA3 corresponding to the third line pixel groups PX31-PX3m connected to the third scan line (not shown). For the comparison between the second pixel data DATA2 and the third pixel data DATA3, the description of the comparison between the first pixel data DATA1 and the second pixel data DATA2 may be equally applied. Therefore, the comparison between the second pixel data DATA2 and the third pixel data DATA3 will not be described.

A section for comparing the first pixel data DATA1 and the second pixel data DATA2 illustrated in FIG. 6 may be referred to as a first period TT1, and a section for comparing the second pixel data DATA2 and the third pixel data DATA3 may be referred to a second period TT2.

According to the present inventive concepts, the data comparison unit 220 sequentially compares the data corresponding to the pixel groups connected to the two scan lines, and thus may output a control signal BCS corresponding to a result value compared for each of the two scan lines to the bias applying unit 240. Accordingly, when the difference between the pixel data DATA corresponding to the two scan lines is small, for example, when the pixel data DATA is a monochromatic pattern, the data comparison unit 220 outputs the second control signal BCS2, and the bias applying unit 240 applies the low bias voltage LBV corresponding to the second control signal BCS2 to the amplifiers AMP, thereby reducing power consumption of the electronic device 10 (see FIG. 1).

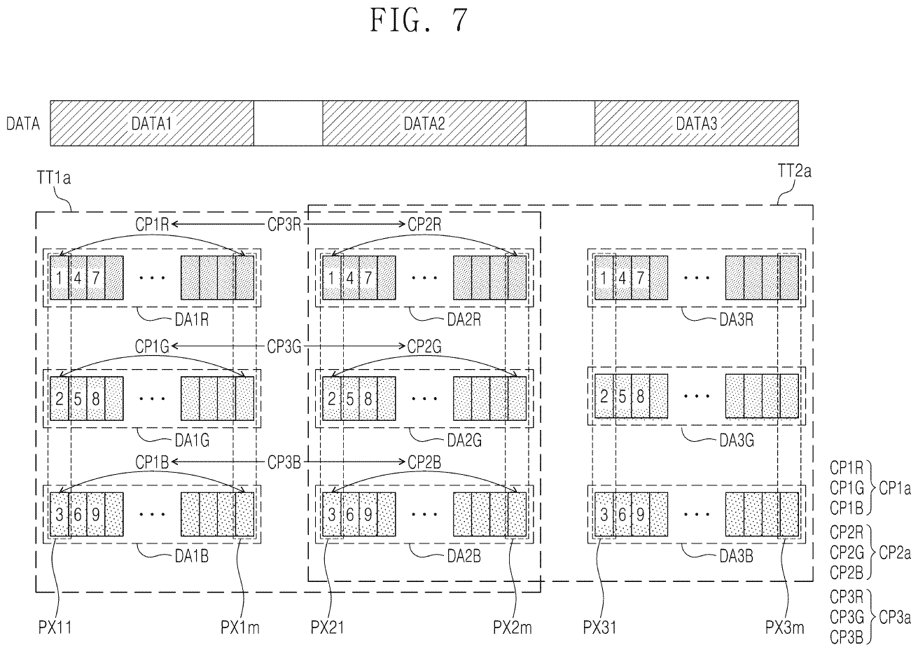

FIG. 7 is a diagram for explaining a driving principle of a data comparison unit 220 (see FIG. 5) according to some example embodiments of the present inventive concepts. In the configuration illustrated in FIG. 7, the same reference numerals are used for the same configuration as that illustrated in FIG. 6, and the description thereof is omitted.

Referring to FIG. 4, FIG. 5, and FIG. 7, the data comparison unit 220 may divide and compare each of the first red pixels R, the first green pixels G, and the first blue pixels B included in the first line pixel groups PX11-PX1m, and may divide and compare the second red pixels R, second green pixels G, and second blue pixels B respectively included in the second line pixel groups PX21-PX2m.

For example, the first pixel data DATA1 may include a plurality of first red pixel data DA1R corresponding to the first red pixels R, a plurality of first green pixel data DA1G corresponding to the first green pixels G, and a plurality of first blue pixel data DA1B corresponding to the first blue pixels B.

The second pixel data DATA2 may include a plurality of second red pixel data DA2R corresponding to the second red pixels R, a plurality of second green pixel data DA2G corresponding to the second green pixels G, and a plurality of second blue pixel data DA2B corresponding to the second blue pixels B.

The data comparison unit 220 may compare each of the first difference CP1a, the second difference CP2a, and the third difference CP3a with a reference value.

In some example embodiments of the present inventive concepts, the first difference CP1a may include a first red difference CP1R between the first red pixel data DA1R, a first green difference CP1G between the first green pixel data DA1G, and a first blue difference CP1B between the first blue pixel data DA1B. Therefore, the data comparison unit 220 may compare each of the first red difference CP1R, the first green difference CP1G, and the first blue difference CP1B with a reference value.

For example, in some example embodiments, the first red difference CP1R may represent a difference in gray scale value between a gray scale value of a first red pixel corresponding to the first red pixel data DA1R that has a largest gray scale value among the first red pixel data DA1R and a gray scale value of a second red pixel corresponding to the first red pixel data DA1R that has a smallest gray scale value among the first red pixel data DA1R such that the first red difference CP1R represents a maximum difference in gray scale value among the first red pixel data DA1R corresponding to two red pixels among the first line pixel groups PX11-PX1M.

For example, in some example embodiments, the first green difference CP1G may represent a difference in gray scale value between a gray scale value of a first green pixel corresponding to the first green pixel data DA1G that has a largest gray scale value among the first green pixel data DA1G and a gray scale value of a second green pixel corresponding to the first green pixel data DA1G that has a smallest gray scale value among the first green pixel data DA1G such that the first green difference CP1G represents a maximum difference in gray scale value among the first green pixel data DA1G corresponding to two green pixels among the first line pixel groups PX11-PX1M.

For example, in some example embodiments, the first blue difference CP1B may represent a difference in gray scale value between a gray scale value of a first blue pixel corresponding to the first blue pixel data DA1B that has a largest gray scale value among the first blue pixel data DA1B and a gray scale value of a second blue pixel corresponding to the first blue pixel data DA1B that has a smallest gray scale value among the first blue pixel data DA1B such that the first blue difference CP1B represents a maximum difference in gray scale value among the first blue pixel data DA1B corresponding to two blue pixels among the first line pixel groups PX11-PX1M.

In some example embodiments of the present inventive concepts, the second difference CP2a may include a second red difference CP2R between the second red pixel data DA2R, a second green difference CP2G between the second green pixel data DA2G, and a second blue difference CP2B between the second blue pixel data DA2B. Therefore, the data comparison unit 220 may compare each of the second red difference CP2R, the second green difference CP2G, and the second blue difference CP2B with the reference value.

For example, in some example embodiments, the second red difference CP2R may represent a difference in gray scale value between a gray scale value of a first red pixel corresponding to the second red pixel data DA2R that has a largest gray scale value among the second red pixel data DA2R and a gray scale value of a second red pixel corresponding to the second red pixel data DA2R that has a smallest gray scale value among the second red pixel data DA2R such that the second red difference CP2R represents a maximum difference in gray scale value among the second red pixel data DA2R corresponding to two red pixels among the second line pixel groups PX21-PX2M.

For example, in some example embodiments, the second green difference CP2G may represent a difference in gray scale value between a gray scale value of a first green pixel corresponding to the second green pixel data DA2G that has a largest gray scale value among the second green pixel data DA2G and a gray scale value of a second green pixel corresponding to the second green pixel data DA2G that has a smallest gray scale value among the second green pixel data DA2G such that the second green difference CP2G represents a maximum difference in gray scale value among the second green pixel data DA2G corresponding to two green pixels among the second line pixel groups PX21-PX2M.

For example, in some example embodiments, the second blue difference CP2B may represent a difference in gray scale value between a gray scale value of a first blue pixel corresponding to the second blue pixel data DA2B that has a largest gray scale value among the second blue pixel data DA2B and a gray scale value of a second blue pixel corresponding to the second blue pixel data DA2B that has a smallest gray scale value among the second blue pixel data DA2B such that the second blue difference CP2B represents a maximum difference in gray scale value among the second blue pixel data DA2B corresponding to two blue pixels among the second line pixel groups PX21-PX2M

In some example embodiments of the present inventive concepts, the third difference CP3a may include a third red difference CP3R between the first red pixel data DA1R and the second red pixel data DA2R, a third green difference CP3G between the first green pixel data DA1G and the second green pixel data DA2G, and a third blue difference CP3B between the first blue pixel data DA1B and the second blue pixel data DA2B.

For example, in some example embodiments of the present inventive concepts, the third red difference CP3R may be a value obtained by comparing the first red difference CP1R, which is the maximum value of the difference of each of the entire gray scales corresponding to the first red pixel data DA1R, with the second red difference CP2R, which is the maximum value of the difference of the respective entire gray scales corresponding to the second red pixel data DA2R. For example, in some example embodiments, the third red difference CP3R may be the difference between the value of the first red difference CP1R and the value of the second red difference CP2R. However, the example embodiments are not so limited thereto and in some example embodiments the third red difference CP3R may be a difference in gray scale value of the first red pixel data DA1R and gray scale value of the second red pixel data DA2R.

For example, in some example embodiments of the present inventive concepts, the third green difference CP3G may be a value obtained by comparing the first green difference CP1G, which is the maximum value of the difference of each of the entire gray scales corresponding to the first green pixel data DA1G, with the second green difference CP2G, which is the maximum value of the difference of the respective entire gray scales corresponding to the second green pixel data DA2G. For example, in some example embodiments, the third green difference CP3G may be the difference between the value of the first green difference CP1G and the value of the second green difference CP2G. However, the example embodiments are not so limited thereto and in some example embodiments the third green difference CP3G may be a difference in gray scale value of the first green pixel data DA1G and gray scale value of the second green pixel data DA2G.

For example, in some example embodiments of the present inventive concepts, the third blue difference CP3B may be a value obtained by comparing the first blue difference CP1B, which is the maximum value of the difference of each of the entire gray scales corresponding to the first blue pixel data DA1B, with the second blue difference CP2B, which is the maximum value of the difference of the respective entire gray scales corresponding to the second blue pixel data DA2B. For example, in some example embodiments, the third blue difference CP3B may be the difference between the value of the first blue difference CP1B and the value of the second blue difference CP2B. However, the example embodiments are not so limited thereto and in some example embodiments the third blue difference CP3B may be a difference in gray scale value of the first blue pixel data DA1B and gray scale value of the second blue pixel data DA2B.

Therefore, the data comparison unit 220 may compare each of the third red difference CP3R, the third green difference CP3G, and the third blue difference CP3B with a reference value.

In some example embodiments of the present inventive concepts, the data comparison unit 220 may compare the second pixel data DATA2 with the third pixel data DATA3. The description of the comparison between the second pixel data DATA2 and the third pixel data DATA3 may be the same as the description of the comparison of the first pixel data DATA1 and the second pixel data DATA2. Therefore, the comparison between the second pixel data DATA2 and the third pixel data DATA3 will not be described.

A period for comparing the first pixel data DATA1 and the second pixel data DATA2 illustrated in FIG. 7 may be referred to as a first period TT1a, and a period for comparing the second pixel data DATA2 and the third pixel data DATA3 may be referred to a second period TT2a.

FIG. 7 may divide and individually compare each of the red pixels, the green pixels, and the blue pixels, as compared to FIG. 6. According to the present inventive concepts, when the pixel data DATA is a monochromatic pattern, for example, a red pattern, a green pattern, a blue pattern, or the like, each of the red pixel data, the green pixel data, and the blue pixel data is different from each other, and thus the amount of change can be individually compared. Therefore, in the case of a monochromatic pattern in which the difference between the pixel data DATA is small, the low bias voltage LBV may be applied to the amplifiers AMP to reduce power consumption of the electronic device 10 (see FIG. 1).

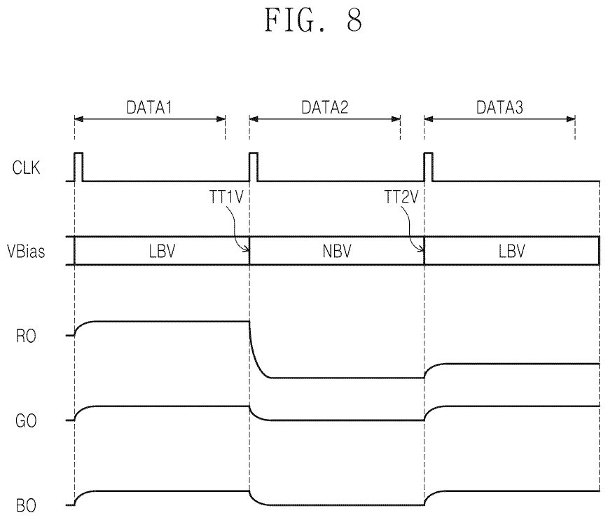

FIG. 8 is a diagram for describing timing at which bias voltages VBias corresponding to each of the first period TT1a and the second period TT2a are applied, according to some example embodiments of the present inventive concepts.

Referring to FIGS. 5, 7, and 8, the bias applying unit 240 may sequentially apply the bias voltage VBias corresponding to the control signal BCS to the entire amplifiers AMP according to the bias clock signal CLK.

FIG. 8 illustrates, as an example, a case where the first pixel data DATA1 and the second pixel data DATA2 corresponding to the first period TT1a are greater than or equal to a reference value as a result of comparison, and illustrates, as an examples, a case where second pixel data DATA2 and third pixel data DATA3 corresponding to the second period TT2a are less than or equal to the reference value as a results of comparison.

In a period in which the first pixel data DATA1 is output, the bias applying unit 240 illustrates, as an example, a state in which the low bias voltage LBV is output. The bias applying unit 240 may receive the first control signal BCS1 corresponding to the first period TT1a from the data comparison unit 220. The bias applying unit 240 may apply a normal bias voltage NBV corresponding to the first control signal BCS1 to the entire amplifiers AMP in a period in which the second pixel data DATA2 is output.

In addition, the bias applying unit 240 may receive the second control signal BCS2 according to the second period TT2a from the data comparison unit 220. The bias applying unit 240 may apply a low bias voltage LBV corresponding to the second control signal BCS2 to each of the amplifiers AMP in a period in which the third pixel data DATA3 is output.

In some example embodiments of the present inventive concepts, the bias voltage VBias may be sequentially applied according to the bias clock signal CLK. In addition, the bias voltage VBias may be controlled corresponding to a time point at which the pixel data DATA is toggled. For example, the normal bias voltage NBV corresponding to the first period TT1a in which the first pixel data DATA1 and the second pixel data DATA2 are compared may be changed and output at a time point at which the first pixel information DATA1 and second pixel information DATA2 are toggled, that is, the first time point TT1V. Accordingly, the bias applying unit 240 may apply the normal bias voltage NBV to each of the amplifiers AMP at the first time point TT1V according to the bias clock signal CLK in response to a comparison of the first pixel data DATA1 and/or the second pixel data DATA2 being greater than or equal to a reference value as a result of comparison.

In addition, the low bias voltage LBV corresponding to the second period TT2a in which the second pixel data DATA2 and the third pixel data DATA3 are compared may be changed and output at a time point at which the second pixel information DATA2 and third pixel information DATA3 are toggled, that is, the second time point TT2V. Accordingly, the bias applying unit 240 may apply the low bias voltage LBV to each of the amplifiers AMP at the second time point TT2V according to the bias clock signal CLK in response to a comparison of the second pixel data DATA2 and third pixel data DATA3 being less than or equal to the reference value.

According to the present inventive concepts, when the pixel data DATA is a monochromatic pattern, since the output change of the data voltages corresponding to the pixel data DATA is small and a high bias voltage is not required, the bias applying unit 240 may apply the low bias voltage LBV to the amplifiers AMP when the difference between the pixel data DATA is small, and apply the normal bias voltage NBV to the amplifier AMP only when the difference between pixel data DATAs is large.

Accordingly, the bias applying unit 240 may apply the normal bias voltage NBV to the amplifiers AMP only when the difference between the first red pixel data DA1R and the second red pixel data DA2R (e.g., CP3R) is equal to or greater than the reference value as a result of comparing the pixel data DATA which is a monochromatic pattern, taking FIG. 8 as an example. At this time, the width of the red output voltage RO may increase according to the difference between the first red pixel data DA1R and the second red pixel data DA2R, and the width of the green output voltage GO according to the difference in the remaining green pixel data and the blue output voltage BO according to the difference of the remaining blue pixel data may be constant.

For example, in some example embodiments, the bias applying unit 240 may independently apply a normal bias voltage NBV or a low bias voltage LBV to a corresponding amplifier AMP within the output unit 280 based on comparison of respective pixel data, for example first red pixel data DA1R and/or second red pixel data DA2R, first green pixel data DA1G and/or second green pixel data DA2G, and/or first blue pixel data DA1B and/or second blue pixel data DA2B. For example, in some example embodiments, when a comparison between first green pixel data DA1G and/or second green pixel data DA2G is greater than the reference value a normal bias voltage NBV may be applied to the amplifies AMP such that a width of a green output voltage GO may be increased. However, the example embodiments are not so limited thereto. For example, in some example embodiments, a normal bias voltage NBV or a low bias voltage LBV may be applied to any of the amplifiers AMP of any given color sub-pixel the first line pixel group PX11-PX1m to the n-th line pixel group PXn1-PXnm based on a comparison of the respective color data of the respective pixel line group. For example, in some example embodiments, a low bias voltage LBV may be applied to amplifies corresponding to green sub-pixels of the second line pixel group PX21-PX2m based on a comparison of the second green pixel data DA2G or a comparison between the second green pixel data DA2G and the third green pixel data DA3G.

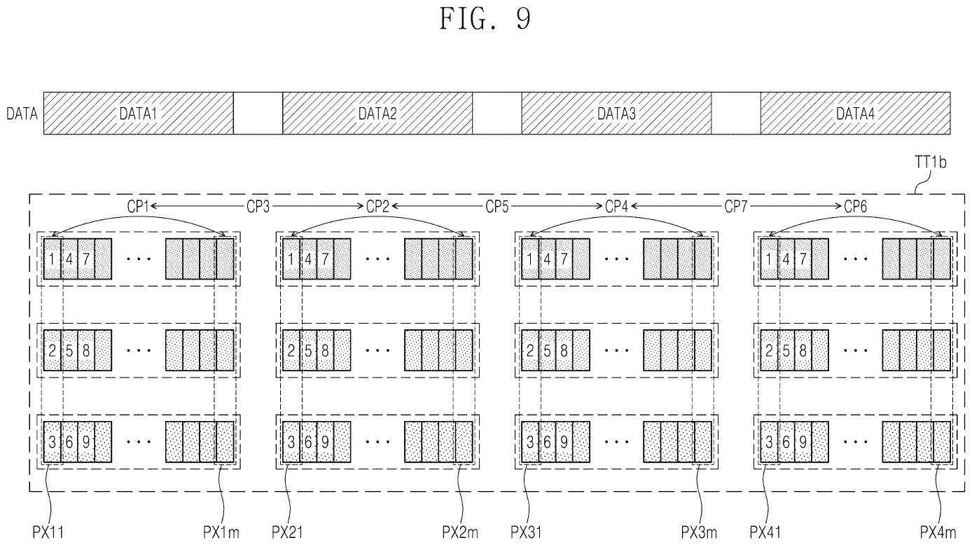

FIG. 9 is a diagram for explaining a driving principle of a data comparison unit 220 (see FIG. 5) according to some example embodiments of the present inventive concepts. In the configuration illustrated in FIG. 9, the same reference numerals are used for the same configuration as that illustrated in FIG. 6, and the description thereof is omitted.

Referring to FIGS. 5 and 9, the pixel data DATA may further include fourth pixel data DATA4. The fourth pixel data DATA4 may be data corresponding to fourth line pixel groups PX41-PX4m electrically connected to a fourth scan line (not shown).

In some example embodiments of the present inventive concepts, the data comparison unit 220 may compare data corresponding to pixel groups connected to the four scan lines. For example, the data comparison unit 220 may compare the first pixel data DATA1 corresponding to the first line pixel groups PX11-PX1m connected to the first scan line GL1 (see FIG. 4), the second pixel data DATA2 corresponding to the second line pixel groups PX21-PX2m connected to the second scan line GL2 (see FIG. 4), the third pixel data DATA3 corresponding to the third line pixel groups PX31-PX3m connected to the third scan line (not shown), and the fourth pixel data DATA4 corresponding to the fourth line pixel groups PX41-PX4m. A section for comparing the first to fourth pixel data DATA1 to DATA4 may be referred to as a first period TT1b.

In some example embodiments of the present inventive concepts, the data comparison unit 220 may compare each of the first difference CP1, the second difference CP2, the third difference CP3, the fourth difference CP4 between the third pixel data DATA3, the fifth difference CP5 between the second pixel data DATA2 and the third pixel data DATA3, the sixth difference CP6 between the fourth pixel data DATA4, and the seventh difference CP7 between the third pixel information DATA3 and the fourth pixel information DATA4 with a reference value.

In some example embodiments of the present inventive concepts, the data comparison unit 220 may output the first control signal BCS1 to the bias applying unit 240 when at least one of the first to seventh differences CP1-CP7 is greater than the reference value. In addition, the data comparison unit 220 may output the second control signal BCS2 to the bias applying unit 240 when all of the first to seventh differences CP1-CP7 are equal to or less than the reference value.

However, the present disclosure is not limited thereto, and the data comparison unit 220 may compare data corresponding to pixel groups connected to x scan lines. The number of x scan lines can be varied. x may be a natural number greater than or equal to 1.

In the above, description has been made with reference to embodiments of the inventive concept, but those skilled or of ordinary skill in the art may understand that various modifications and changes may be made to the inventive concept insofar as such modifications and changes do not depart from the spirit and the technical scope of the inventive concept set forth in the claims to be described later.

Therefore, the technical scope of the inventive concept is not limited to the contents stated in the detailed description of the specification, but should be determined by the claims.

What is claimed is:

1. An electronic device comprising:
a plurality of first line pixel groups;
a plurality of second line pixel groups;
a plurality of data lines electrically connected to the plurality of first line pixel groups and the plurality of second line pixel groups, each data line of the plurality of data lines extending in a first direction;
a plurality of amplifiers electrically connected to the plurality of data lines, respectively;
a data comparison unit configured to output a control signal, the data comparison unit configured to output the control signal based on a result of sequentially comparing a plurality of first pixel data corresponding to the plurality of first line pixel groups and a plurality of second pixel data corresponding to the plurality of second line pixel groups; and
a bias applying unit configured to receive the control signal from the data comparison unit, the bias applying unit configured to apply a bias voltage corresponding to the control signal to each of the plurality of amplifiers,
wherein the data comparison unit is configured to compare
a first difference between the plurality of first pixel data with a reference value,
a second difference between the plurality of second pixel data with the reference value, and
a third difference between the first difference and the second difference with the reference value.

2. The electronic device of claim 1, wherein the data comparison unit is configured to output a first control signal to the bias applying unit in response to at least one of the first difference, the second difference, or the third difference being greater than the reference value, and
wherein the bias applying unit is configured to apply a normal bias voltage to each of the plurality of amplifiers in response to receiving the first control signal.

3. The electronic device of claim 2, wherein the data comparison unit is configured to output a second control signal to the bias applying unit in response to all of the first difference, the second difference, and the third difference being equal to or less than the reference value, and
wherein the bias applying unit is configured to apply a low bias voltage corresponding to each of the plurality of amplifiers in response to receiving the second control signal.

4. The electronic device of claim 1, wherein
the plurality of first line pixel groups includes a plurality of first red pixels, a plurality of first green pixels, and a plurality of first blue pixels,
the plurality of second line pixel groups includes a plurality of second red pixels, a plurality of second green pixels, and a plurality of second blue pixels,
each first line pixel group of the plurality of first line pixel groups includes a first red pixel of the plurality of first red pixels, a first green pixel of the plurality of first green pixels, and a first blue pixel of the plurality of first blue pixels, and
each second line pixel group of the plurality of second line pixel groups includes a second red pixel of the plurality of second red pixels, a second green pixel of the plurality of second green pixels, and a second blue pixel of the plurality of second blue pixels.

5. The electronic device of claim 4, wherein the plurality of first pixel data includes a plurality of first red pixel data corresponding to the plurality of first red pixels, a plurality of first green pixel data corresponding to the plurality of first green pixels, and a plurality of first blue pixel data corresponding to the plurality of first blue pixels, and
wherein the plurality of second pixel data includes a plurality of second red pixel data corresponding to the plurality of second red pixels, a plurality of second green pixel data corresponding to the plurality of second green pixels, and a plurality of second blue pixel data corresponding to the plurality of second blue pixels.

6. The electronic device of claim 5, wherein the first difference includes a first red difference between the plurality of first red pixel data, a first green difference between the plurality of first green pixel data, and a first blue difference between the plurality of first blue pixel data, and
wherein the second difference includes a second red difference between the plurality of second red pixel data, a second green difference between the plurality of second green pixel data, and a second blue difference between the plurality of second blue pixel data.

7. The electronic device of claim 6, wherein the third difference includes a third red difference between the first red difference and the second red difference, a third green difference between the first green difference and second green difference, and a third blue difference between the first blue difference and second blue difference.

8. The electronic device of claim 1, wherein the plurality of first pixel data includes a gray scale value corresponding to each first line pixel group of the plurality of first line pixel groups, and
wherein the plurality of second pixel data includes a gray scale value corresponding to each second line pixel group of the plurality of second line pixel groups.

9. The electronic device of claim 8, wherein the reference value is a difference in gray scale value equal to 1.

10. The electronic device of claim 8, wherein the reference value is a difference in gray scale value equal to 10.

11. The electronic device of claim 1, further comprising:
a first scan line extending in a second direction intersecting the first direction and electrically connected to the plurality of first line pixel groups; and
a second scan line extending in the second direction and electrically connected to the plurality of second line pixel groups.

12. The electronic device of claim 1, further comprising:
a latch that is configured to sequentially store a plurality of pixel data including the plurality of first pixel data and the plurality of second pixel data;
a control unit including the data comparison unit, the control unit configured to output the plurality of pixel data to the latch;
a level shifter configured to receive the plurality of pixel data from the latch, the level shifter further configured to change voltage levels of the plurality of pixel data received from the latch; and
a conversion unit configure to receive the plurality of pixel data in digital form, the conversion unit further configured to convert the plurality of pixel data into a plurality of data voltages in analog form using a gamma reference value.

13. The electronic device of claim 1, further comprising:
a plurality of third line pixel groups; and
a plurality of fourth line pixel groups,
wherein the data comparison unit is further configured to compare a plurality of third pixel data corresponding to the plurality of third line pixel groups and a plurality of fourth pixel data corresponding to the plurality of fourth line pixel groups.

14. A method of driving an electronic device, the method comprising:
receiving a plurality of first pixel data corresponding to a plurality of first line pixel groups and a plurality of second pixel data corresponding to a plurality of second line pixel groups;
comparing a first difference between the plurality of first pixel data with a reference value;
comparing a second difference between the plurality of second pixel data with the reference value;
comparing a third difference between the first difference and the second difference with the reference value; and
outputting a first control signal to a bias applying unit in response to at least one of the first difference, the second difference, or the third difference being greater than the reference value, and outputting a second control signal to the bias applying unit in response to all of the first difference, the second difference, and the third difference being equal to or less than the reference value.

15. The method of claim 14, wherein the bias applying unit applies a normal bias voltage corresponding to the first control signal to each of a plurality of amplifiers in response to the bias applying unit receiving the first control signal, and applies a low bias voltage corresponding to the second control signal to each of the plurality of amplifiers in response to receiving the second control signal.

16. The method of claim 14, wherein
the plurality of first line pixel groups includes a plurality of first red pixels, a plurality of first green pixels, and a plurality of first blue pixels,
the plurality of second line pixel groups includes a plurality of second red pixels, a plurality of second green pixels, and a plurality of second blue pixels,
each first line pixel group of the plurality of first line pixel groups includes a red pixel of the plurality of first red pixels, a first green pixel of the plurality of first green pixels, and a first blue pixel of the plurality of first blue pixels, and
each second line pixel group of the plurality of second line pixel groups includes a second red pixel of the plurality of second red pixels, a second green pixel of the plurality of second green pixels, and a second blue pixel of the plurality of second blue pixels.

17. The method of claim 16, wherein the plurality of first pixel data includes a plurality of first red pixel data corresponding to the plurality of first red pixels, a plurality of first green pixel data corresponding to the plurality of first green pixels, and a plurality of first blue pixel data corresponding to the plurality of first blue pixels, and
wherein the plurality of second pixel data includes a plurality of second red pixel data corresponding to the plurality of second red pixels, a plurality of second green pixel data corresponding to the plurality of second green pixels, and a plurality of second blue pixel data corresponding to the plurality of second blue pixels.

18. The method of claim 17, wherein the first difference includes a first red difference between the plurality of first red pixel data, a first green difference between the plurality of first green pixel data, and a first blue difference between the plurality of first blue pixel data,
wherein the second difference includes a second red difference between the plurality of second red pixel data, a second green difference between the plurality of second green pixel data, and a second blue difference between the plurality of second blue pixel data, and
wherein the third difference includes a third red difference between first red difference and the second red difference, a third green difference between the first green difference and second green difference, and a third blue difference between the first blue difference and second blue difference.

19. The method of claim 14, wherein the plurality of first pixel data includes a plurality of first gray scale values, each first gray scale value of the plurality of first gray scale values corresponding to a respective first line pixel group of the plurality of first line pixel groups,
wherein the plurality of second pixel data includes a plurality of second gray scale values, each second gray scale value of the plurality of second gray scale values corresponding to a respective second line pixel group of the plurality of second line pixel groups, and
wherein the reference value is a difference in gray scale value equal to 1.

20. An electronic device comprising:
a display panel including a plurality of pixel groups;
a data driving circuit configured to output a plurality of data voltages, each data voltage of the plurality of data voltages corresponding to a respective pixel group of the plurality of pixel groups; and
a processor configured to control the display panel and the data driving circuit,
wherein the data driving circuit includes
a data comparison unit configured to output a control signal, the data comparison unit configured to output the control signal based on a result of sequentially comparing a plurality of first pixel data corresponding to a plurality of first line pixel groups and a plurality of second pixel data corresponding to a plurality of second line pixel groups;
a bias applying unit configured to receive the control signal from the data comparison unit, the bias applying unit further configured to output a bias voltage corresponding to the control signal; and
a plurality of amplifiers configured to receive the bias voltage from the bias applying unit,
wherein the data comparison unit is configured to compare
a first difference between the plurality of first pixel data with a reference value,
a second difference between the plurality of second pixel data with the reference value, and
a third difference between the first difference and the second difference with the reference value.
